(19) United States
(12) Patent Application Publication
(10) Pub. No.: US 2024/0408522 A1
(43) Pub. Date: Dec. 12, 2024

(54) AIR FILTER WITH ABLATIVE AND SACRIFICIAL POLYMERS

(71) Applicant: Industrial Polymers and Chemicals, Inc., Shrewsbury, MA (US)

(72) Inventors: Thomas J. Kennedy, III, Shrewsbury, MA (US); Ralph G. Dacey, JR., Shrewsbury, MA (US); Robert Roth, St. Louis, MO (US); Jonathan Barnes, Shrewsbury, MA (US)

(21) Appl. No.: 18/634,687

(22) Filed: Apr. 12, 2024

Related U.S. Application Data
(60) Provisional application No. 63/459,634, filed on Apr. 15, 2023.

(51) Int. Cl. B01D 39/20

(52) U.S. Cl. CPC B01D 39/2024; B01D 2239/0442; B01D 2239/0492

(57) ABSTRACT

A polymer comprising a pathogen inactivating component such that the pathogen inactivating component is released continuously over time by the ablation or sacrifice of the polymer. The polymer may be incorporated onto or into an air filter.

### CROSS-REFERENCE TO RELATED APPLICATIONS

This application claims the benefit of priority to U.S. Provisional Patent Application No. 63/459,634 entitled “Air Filter with Ablative and Sacrificial Polymers,” filed on Apr. 15, 2023, the contents of which are incorporated by reference herein in its entirety.

### TECHNICAL FIELD

The present application generally related to biocides and, more particularly, to such biocides infused within an ablative or sacrificial polymer.

### BACKGROUND

Air filters for HVAC systems provide for the filtration of particles that are entrained in the impinging air. Depending upon the rating of the filter, smaller and smaller particles may be filtered out of the air. A specific type of filter, high efficiency particulate air (HEPA) filter, is utilized to filter micron and submicron particles from the air.

While very fine particle filters offer trapping of allergens and other problematic materials such as fine dust, all of these passive air filters do not allow for the inactivation of pathogens that may be borne by the air as it flows through the HVAC system. HEPA filters may also cause a high pressure drop across the filter, resulting in poor airflow through the HVAC system.

Thus, there is therefore a need for a long-lasting, pathogen inactivating, and high percentage capture air filter for HVAC systems.

### SUMMARY

The embodiment is the use of specialty polymers and pathogen inactivating materials where the specialty polymers are ablative or sacrificial. These specialty polymers incorporating pathogen inactivating materials may be utilized in air filters comprised of paper, woven fiberglass, nonwoven fiberglass, nonwoven polymers, electrospun polymer fibers and the like where the air filter or filters further comprise a method of inactivating pathogens through the use of a compound or compounds that are infused, coated or otherwise incorporated into or onto the air filters.

The embodiment is also the use of a new polymeric material for the inactivation of pathogenic materials. This polymeric material may be woven into the air filter matrix or coated onto the air filter matrix or both.

The embodiment also includes the grafting of the pathogen inactivating material onto the specialty polymer backbone.

The air filter or filters further comprise a polymer that is infused or mixed with a compound, such as a biocide, that will inactivate pathogens such as viruses, bacteria, and fungus. The polymer may also have ablative or sacrificial characteristics where the surface of the polymer may wear down with time, exposing a new fresh surface of the polymer where the ablative polymer is concerned or a bulk breakdown of the polymer where a sacrificial polymer is concerned.

The ablative or sacrificial polymer may be an emulsion polymer comprised of a polyvinyl acetate and acrylate backbone where the outer surface of the polymer will be worn away over time, exposing a new surface to the environment.

The biocide infused polymer may also be compounded such that, when coated onto the filter substrate, provides a continuous supply of the virucide or virucide to the air that is flowing through the filter. This process may also be known as bioactive filtration.

One method of accomplishing bioactive filtration is to introduce a large excess of biocide into the polymer mixture such that the biocide comes to the surface of the polymer through surface energy differences, diffusion, capillary action, or other passive transport mechanisms.

Yet another method of supplying a continuous amount of pathogen inactivating material is for the ablative or sacrificial polymer matrix to wear away over time while continuously exposing the pathogen inactivating material that has been infused into the polymer matrix to the environment.

The polymer that is coated on the filter system may also be of such a nature that it is incompatible with the biocide such that the biocide, or any other material that would inactivate a pathogen, is allowed to ooze or flow out of the polymer matrix. This would be similar to a permanently oiled bearing where oil is infused into a sintered bearing and thus has long life lubrication as the oil oozes out of the sintered bearing. The polymer matrix may be a solid, solution, or emulsion type. The polymer may be borne by an organic solvent or may be waterborne or maybe 100% solids.

The virucide or biocide or fungicide may be a blend of virucides or biocides or fungicides, each having a different target area of pathogens. As a result, multiple pathogens, such as Legionella, the pathogen causing Legionnaires' disease, and SARS-CoV-2, the virus causing the Covid-19 pandemic and Candida auris, may be inactivated at the same time.

Filter papers are used in many types of applications including air filters for HVAC units and automobiles, coffee filters, fuel filters, chromatography separation, laboratory filters, and teabags to name a few applications. Porous air filters in HVAC systems may be manufactured in a manner to allow particles of different sizes to be trapped while other sizes may pass through the filter.

These filter papers have benefited from continued refinement and engineering to provide sustained and precise filtration methods for various materials.

Single-digit and fractional micron filtration is possible with many different types of filter paper. The filter papers may also be treated with biocides and virucides to improve the protection from infectious particles that may be circulating in the air.

The coating of the filter substrate may be accomplished by a spray, dip, roll, print, or other transfer process whereby an ablative or sacrificial polymer is transferred to the surface of the specialty paper. The ablative or sacrificial polymer may contain pathogen inactivating material such as a biocide or virucide. The roll process may be a Mayer rod process or a gravure process.

A fiberglass base material may be utilized for the HVAC filter. Here, the ablative or sacrificial polymer with a biocide or a virucide, or any other material that would inactivate a pathogen, is transferred to the fiberglass substrate. The fiberglass substrate may be woven or nonwoven. The ablative or sacrificial polymer will wear over time and exposed a new surface to the environment while it is coated on the fiberglass substrate.

The rating of the air filter may be of various levels. The American Society of Heating, Refrigerating and Air-Conditioning Engineers (ASHRAE) utilizes the standard as prescribed by ANSI/ASHRAE 52.2 for the Minimum Efficiency Reporting Value (MERV). A standard of MERV 13 or higher has been prescribed by the Center for Disease Control (CDC).

There are various biocides and virucides and fungicides available in the marketplace for the inactivation of pathogens, including the SARS-COV-2 virus that is causing the Covid-19 pandemic. The biocides and virucides and fungicides include materials that incorporate chlorinated molecules such as quaternary ammonium salts with a chlorine molecule attached. Benzalkonium chloride is an example of the material with a quaternary ammonium component and a chlorine component. Many other types of biocides and virucides are available such as sodium hypochlorite (commonly known as bleach), hydrogen peroxide, and isopropyl alcohol. Other molecules include boron, iodine, and other chlorine containing molecules. Materials containing hydrogen peroxide or that generate hydrogen peroxide are also effective biocides, virucides, and fungicides.

The polymers that are utilized in this embodiment have special characteristics for the changes of the polymers over time. Both ablative polymers and sacrificial polymers may be utilized for the coating material on the air filters. Ablative polymers tend to break down from the surface do to external forces such as the flow of a fluid, such as air, over the surface of the ablative polymer. Sacrificial polymers tend to break down in a bulk manner where the entire sacrificial polymer begins to break down from external forces such as the flow of the fluid over the surface of the sacrificial polymer. Various polymeric properties may be manipulated to produce either an ablative polymer or a sacrificial polymer.

### BRIEF DESCRIPTION OF THE DRAWINGS

The foregoing aspects and other features of the disclosed embodiments are explained in the following description, taken in connection with the accompanying drawings, wherein:

FIG. 1 illustrates an exemplary embodiment of an HVAC filter with a virucide infused coated fiberglass component.

FIG. 2 is a proposed production scheme for a polylipid.

FIG. 3 is the Menshutkin reaction utilized for the conversion of a tertiary amine into a quaternary ammonium salt via reaction with an alkyl halide.

FIG. 4 is a chemical formula for benzalkonium chloride like materials with n=the alkyl component.

FIG. 5 is a further substituted benzalkonium chloride like molecule where substitution is through the aromatic group.

FIG. 6 is chloromethyl styrene.

FIG. 7 is N, N-dimethylalkylamine

FIG. 8 is bromomethyl styrene.

FIG. 9 is fluoromethyl styrene.

FIG. 10 is a group of various polysaccharides.

FIG. 11 is a benzalkonium chloride functionalized vinyl acetate 2-ethylhexyl acrylate copolymer.

FIG. 12 is a vinyl acetate 2-ethylhexyl acrylate copolymer with an ester linkage alkonium chloride functionality.

FIG. 13 is a hydroxy ethyl cellulose polymer.

FIG. 14 is a quaternary ammonium functionalized hyaluronic acid.

FIG. 15 is a scanning electron micrograph (SEM) micrograph of sprayed and dried polymeric droplets on a filamentous air filter substrate.

FIG. 16 is a SEM micrograph of non-coded filaments in an air filter substrate.

### DETAILED DESCRIPTION

The embodiments described herein disclose a polymer where the polymer contains an agent, such as a pathogen inactivating material, for inactivating viruses, bacteria, and fungi. Specifically, the biocide in the polymer is used to inactivate the SARS-COV-2 virus causing the Covid-19 pandemic. This process is known as bioactive filtration.

The polymer may be an ablative or sacrificial polymer that will wear away at the surface over time or degrade in a bulk manner, thus exposing new material to the environment. The polymer may also be a material that's incompatible with the pathogen inactivating agent such that the pathogen inactivating agent, a biocide, will ooze out of the polymer for a long period of time and thus inactivate a pathogen, such as viral particles, when they impinge on an air filter.

An ablative or sacrificial polymer may also be known as a sacrificial material with the polymer subject to wear from environmental conditions. The ablation of a polymeric matrix may occur from thermal interaction, UV interaction, and other energetic, oxidating, or hydrogenating environmental interactions. The ablative or sacrificial polymer may also be comprised of nano composites. The sacrificial polymer may wear away and break down from environmental interactions.

The polymeric material, blended with a biocide, or any pathogen inactivating material, may be applied to the substrate by various means such as spraying, dipping, roll coating, and printing. Once the polymer is applied to the substrate, it may be cured or dried through various processes such as UV cure, drying in a heated oven, or air dried.

In yet another process, filaments of an ablative polymer that are combined with a pathogen inactivating material may be co-mingled with a secondary or tertiary polymer filament such that the ablative pathogen inactivating polymer is part of a polymer fiber filter matrix. Other polymers, such as polyolefins, may be utilized to form the rest of the polymer fiber filter matrix. This polymer fiber filter matrix may also be subsequently coated with a secondary material to further enhance the filtration and pathogen inactivating capabilities.

The configuration of the multiple polymer filaments, in one embodiment, allows for electrostatic and pathogenic material interaction between the filaments, thus causing the spaces in the polymer fiber filter matrix to act in a pathogen inactivating manner as well. This process is akin to the use of mosquito repellent netting where the spaces in the netting, as well as the coated fibers in the netting structure itself, still acts to repel the malaria carrying mosquitoes and thus protect anyone inside of the netting structure.

Test procedures, such as ISO-18184:2019, may be utilized to demonstrate the anti-viral capacity of porous substrates. In accordance with ISO-18184:2019, samples of a non-woven fiberglass with a MERV rating of 13 treated with a polyvinyl acetate/acrylate copolymer infused with Stepan BTC-885, a benzalkonium chloride containing mixture, were tested. A material containing essentially 99.9% benzalkonium chloride was also tested. The pathogen that was tested utilizing the ISO-18184:2019 standard was the SARS-COV-2 virus, WA1 strain. The results of the testing show that the polymer and virucide infused non-woven fiberglass MERV 13 filter inactivated all of the SARS-COV-2 WA1 virus in 15 minutes. The test results are listed below in Table 1.

TABLE 1

| | Project | Lot | | Test | Contact | Log₁₀ |
|---|---|---|---|---|---|---|
| Protocol # | No. | No. | Dilution | Virus | time | Reduction |
| IPAC.V.21.001 | 1123- | Test | N/A | Severe | 15 | ≥3.39 |
| | 101 | Material | | Acute | Minutes | |
| | | | | Respirator | | |
| | | | | Syndrome- | | |
| | | | | Related | | |
| | | | | Coronavirus | | |
| | | | | 2 (SARS- | | |
| | | | | CoV-2) | | |
| | | | | (COVID-19 | | |
| | | | | Virus) | | |

When a coating is used to apply the ablative or sacrificial polymer containing the pathogen inactivating material to an air filter, the substrate that the polymer is coated onto may be composed of various materials. The materials include both woven and nonwoven fiberglass, paper, nonwoven polymeric matrices, woven polymeric matrices, and similar support materials.

A second set of results show the data in table 2 where different levels of benzalkonium chloride were infused into the polyvinyl acetate/acrylate polymer. The parts by weight (pbw) of the benzalkonium chloride was incorporated at various levels. The benzalkonium chloride in this test was a 99.5% material while the BTC-885 material is 50% active with the other 50% being surfactant materials.

TABLE 2

| | Number | Coating | Polymer |
|---|---|---|---|
| 1 | IPAC-08222022- | Fiberglass control - MERV-13 | None |
| | 001 | JM | |
| 2 | IPAC-08222022- | Polymer control | SC-6125 |
| | 002 | | |
| 3 | IPAC-08222022- | Polymer + 1.25 pbw BAC | SC-6125 |
| | 003 | | |
| 4 | IPAC-08222022- | Polymer + 2.5 pbw BAC | SC-6125 |
| | 004 | | |
| 5 | IPAC-08222022- | Polymer + 5.0 pbw BAC | SC-6125 |
| | 005 | | |
| 6 | IPAC-08222022- | Polymer + 10.0 pbw BAC | SC-6125 |
| | 006 | | |

Table 3 shows the results of the testing of the materials in table 2.

TABLE 3
Viral Reduction

| | | Contact | Initial Load | Output Load | Log₁₀ |
|---|---|---|---|---|---|
| Test Substance | Replicate | Time | (Log₁₀TCID₅₀)* | (Log₁₀TCID₅₀) | Reduction |
| IPAC-08222022-002 | 1 | 15 minutes | 5.92 | 5.60 | 0.32 |
| | 2 | | | 5.48 | 0.44 |
| IPAC-08222022-003 | 1 | | | 5.23 | 0.69 |
| | 2 | | | 4.85 | 1.07 |
| IPAC-08222022-004 | 1 | | | 3.85 | 2.07 |
| | 2 | | | 3.85 | 2.07 |
| IPAC-08222022-005 | 1 | | | 1.89 | 4.03 |
| | 2 | | | ≤2.13 | ≥3.79 |
| IPAC-08222022-006 | 1 | | | ≤2.13 | ≥3.79 |
| | 2 | | | ≤2.13 | ≥3.79 |

*Input load is derived from the average of the two replicates of the control fabric
≥Denotes a complete inactivation of the virus challenged.

This test is designed to evaluate the virucidal effectiveness of the polymer matrix consisting of at least a base ablative or sacrificial polymer and a pathogen inactivating material infused into the polymer matrix against SARS-associated Coronavirus Type 2 (SARS-COV-2). The test determined the potential of the pathogen inactivating infused polymer matrix to inactivate the test virus via direct contact. The test is designed to simulate consumer use; and is based on the International Standard ISO 18184 method, “Textiles-Determination of Antiviral Activity of Textile Products”.

The results show the complete inactivation of the SARS-COV-2 virus at a 10 pbw level of the pathogen inactivating material and a complete inactivation to a 4.03 log reduction of the SARS-COV-2 virus at a 5 pbw level of the pathogen inactivating material.

The polymeric coated or polymeric modified substrate may then be fitted into a frame such that it may easily be inserted into an HVAC system that currently accepts regular types of filtration media. The frame may be comprised of metal, plastic, paper, fiberglass or other materials or combination of materials. A stiffening member may also be integrated into or with the polymeric coated or polymeric modified substrate so as to stiffen the polymeric coated or polymeric modified substrate and allow the polymeric coated or polymeric modified substrate to withstand the air flow of an HVAC system without substantially deforming.

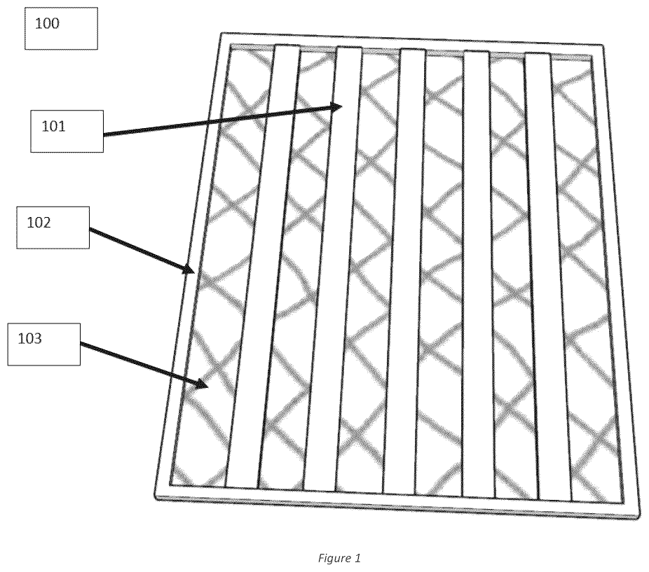

FIG. 1 is a depiction of an air filter 100. The cross members 101 of the air filter frame 102 retain the filtration substrate 103. The filtration substrate 103 may be a woven or non-woven substrate. The material of the filter substrate 103 may be paper, fiberglass, or another suitable material. The filtration substrate 103 may be coated with a polymer where the polymer is infused with a virucide. The filtration substrate 103 may also be a co-mingled fiber matt that forms of polymer filter fiber matrix comprised of ablative polymer filaments that are woven with other polymer filaments such as polyolefins or polyurethanes.

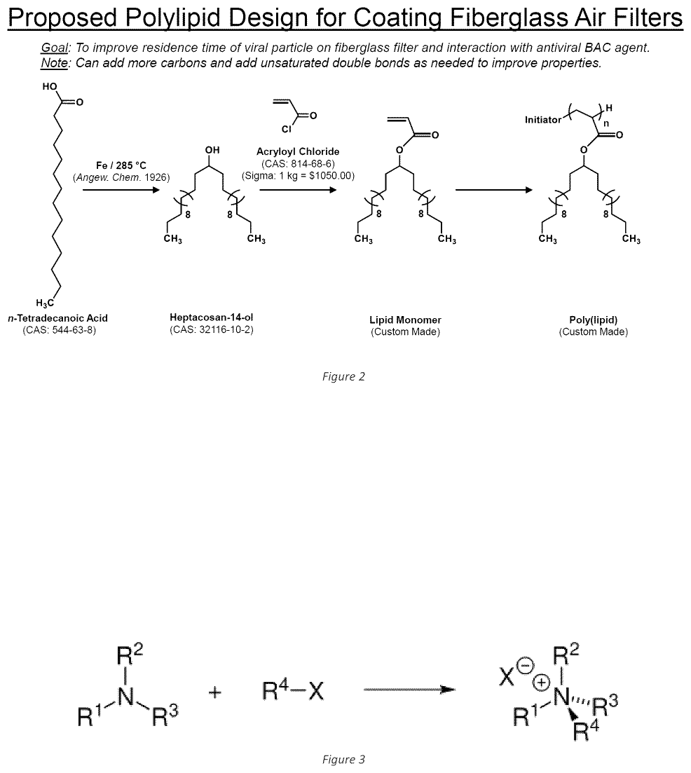

FIG. 2 depicts a polylipid production scheme where the polylipid may subsequently be utilized as a coating on an air filter as a pathogen inactivating component.

FIG. 3 is the general reaction scheme for the Menshutkin reaction whereby quaternary ammonium salts may be produced utilizing tertiary amines and alkyl halides. The halogen component of the alkyl halides may be chlorine, bromine, fluorine, or iodine. Modification of these quaternary ammonium salts may produce other polymers that may be utilized to inactivate various pathogens.

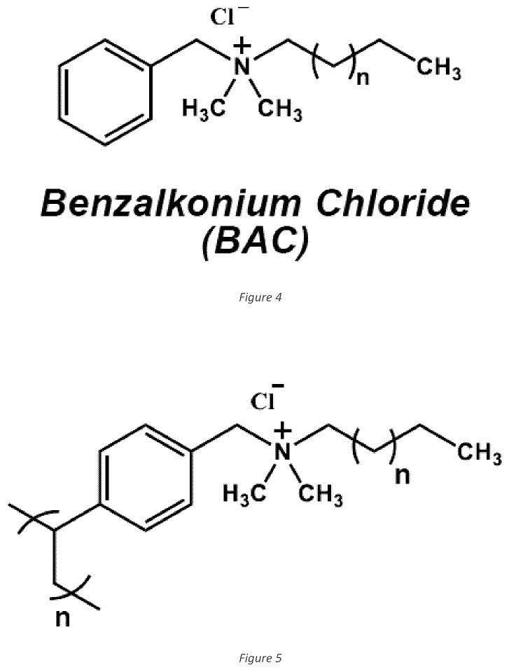

FIG. 4 depicts the benzalkonium chloride, one of the compounds that may be made utilizing the Menshutkin reaction.

FIG. 5 is a depiction of substitution of the aromatic ring of benzalkonium chloride to produce a new polymer as a pathogen inactivating material.

Another virucide is didecyldimethylammonium chloride (DDMAC). It is a broad spectrum bactericide, virucide, and fungicide and can be used as disinfectant cleaner for linen, recommended for use in hospitals, hotels and industries.

Changes in the morphology of ablative and sacrificial polymers takes place over a period of time. It is useful to understand how these changes take place so that pathogen inactivating materials that are incorporated into the polymers may be presented in the best method possible to achieve the inactivation of the various targeted pathogens.

Two major changes seen are surface changes and bulk changes of the polymer matrix. One measurement for the active transport process in polymers is known as the second Damköhler number. In its most commonly used form, the Damköhler number relates the reaction timescale to the convection time scale, volumetric flow rate, through a reactor for continuous (plug flow or stirred tank) or semibatch chemical processes. This time related transport process may be related to the breakdown of polymeric materials to show surface or bulk degradation.

In reacting systems that include interphase mass transport, such as water vapor passing through the interstices of a polymer matrix, the second Damköhler number (Dₐ_{₁₁}) is defined as the ratio of the chemical reaction rate to the mass transfer rate. It is also defined as the ratio of the characteristic fluidic and chemical time scales.

The second Damköhler number may be utilized to describe surface versus bulk degradation based on the mass transfer of materials at the polymer/environmental interface.

$${D}_{{a}_{II}} = \frac{{k}_{eff}}{\frac{{D}_{{H}_{2} O}}{{L}^{2}}}$$

Where k_{eff}=reaction rate constant with units of time of 1/seconds, D_{H}_{₂}_{O}=diffusivity (of water here) within the polymer and has units of meters²/seconds, and L²=shortest distance from the surface of the polymer to the core of the polymer and would be in meters.

Bulk degradation is the breaking of any polymer bond breaking at any time. An example of this is hydrolytic degradation where water diffuses freely through out the polymer structure. As a result of the bulk degradation, the volume remains constant but the chemical bonds decrease in number.

Surface degradation, on the other hand, is where only the polymer bonds on the surface are degraded and the core of the polymer remains intact. As a result of the constant surface degradation, the volume will decrease with time but within the remailing solid, the bonds are constant.

Thus, very high k_{eff} and a low D_{H}_{₂}_{O} would be associated with surface degradation and a low k_{eff} and high D_{H}_{₂}_{O} would be associated with bulk degradation.

Ablative polymers will be associated with a very high k_{eff} and a low D_{H}_{₂}_{O} while sacrificial polymers will be associated with a low k_{eff} and high D_{H}_{₂}_{O}.

Polymers with surface degradation will have a high Damköhler number while polymers with bulk degradation will have a low Damköhler number.

A degradation labile molecule may be built into the backbone of the polymer so as to increase the ablation or sacrifice of the polymer over time. This degradation labile molecule may include a starch molecule or a cellulose molecule.

The degradation labile molecule may also be subject to enzymatic degradation through the use of a specific enzyme or enzymes that are incorporated into the polymer matrix.

The enzyme in the polymer matrix may be encapsulated so as to be released over time. The encapsulation of the enzyme may be such that the encapsulation will degrade and release the enzyme continuously or at different time intervals. This may be accomplished through the use of the material such as polyvinyl alcohol where the molecular weight of the polyvinyl alcohol is modified to increase or decrease the degradation of the encapsulation portion of the encapsulated enzyme.

The tacticity of the polymer will also have an effect on the degradation of the polymer matrix. The tacticity of a polymer is the relative stereochemistry of adjacent chiral centers within a macromolecule such as a polymer. The changes in the stereochemistry will allow for more or less diffusivity into the polymer matrix of materials that will cause more or less degradation of the polymer matrix, such as water.

The release of the virucide or biocide from the ablative or sacrificial polymer may also be modulated through the use of oil absorbent of materials such as silicas, talcs, clays, molecular sieves, materials with a high degree of porosity such as diatomaceous earth, Zeolites, silica gel and other absorptive materials that may be incorporated into the polymer matrix. These materials may absorb the pathogen inactivating material and release it over time, the amount of the release depending upon environmental conditions.

The absorptive materials may be microporous, mesoporous, or macroporous. Microporous materials will have pores that are less than 2 nm. Mesoporous materials will have pores from 2 nm to 50 nm. Macroporous materials will have poor openings from 20 to 100 nm.

Release of a virucide or biocide from the oil absorptive materials will depend upon the environmental conditions once they are exposed to the environment after the sloughing off of the ablative polymer or the breakdown of the sacrificial polymer. Temperature, atmospheric pressure, and humidity will play a role in the release of the virucide or biocide from the absorptive materials once exposed to the environment.

The ablation or sacrifice of the polymer matrix may be modulated through the modification of the polymer matrix by the incorporation of materials such as cellulosic materials and starch materials. The process of ablation or sacrifice of the polymer matrix may be increased through the use of hydrophilic moieties and enzymatic materials which will help to increase the speed of degradation, either through ablation or sacrificial processes, of the polymer matrix.

The ablation or sacrifice of the polymer matrix may also be modulated through the modification of the polymeric bonds so as to increase or decrease the ablation or sacrifice of the polymeric matrix. For instance, ester bonds may be grafted into the backbone of the polymer matrix to allow for an area of chain scission via hydrolysis from interaction with water molecules.

Another molecule that may be grafted into the backbone of the polymeric matrix are starch molecules. For instance, a polyvinyl acetate-starch copolymer may be produced. The starch molecule will allow for the breakdown of the polymer at a faster rate than a polyvinyl acetate homopolymer would break down over time.

A polyvinyl acetate/2-ehtylhxyl copolymer emulsion that is stabilized with cellulose may also be copolymerized with the starch molecule such that a starch molecule is built into the backbone of the vinyl acetate/acrylate copolymer. Here again, the starch molecule will allow for accelerated breakdown of the polymer while the acrylate copolymer will allow for flexibility of the polymer backbone. Other acrylate moieties may be utilized to flexible eyes the polymer backbone. These include butyl acrylate and ethel acrylate.

The use of a starch enzyme will allow for cleavage of the polymer backbone of the vinyl acetate/acrylate copolymer starch complex. One such enzyme is amylase. The enzymatic action of the amylase enzyme will allow for the breakdown of the polymeric matrix over time. Through the inclusion of various amounts of amylase enzyme, the breakdown of the polymer may be throttled to the desired time domain.

Another molecule may be grafted into the backbone of the polymer matrix is cellulose. A cellulose type molecule grafted into the backbone of a vinyl acetate acrylic copolymer, such as a vinyl acetate butyl acrylate copolymer or a vinyl acetate 2-ethyl hexyl acrylate copolymer will allow the polymeric matrix to be susceptible to both surface breakdown, and thus a ablative polymer matrix, and bulk breakdown, and thus a sacrificial polymer matrix.

Enzymes that will act on the cellulosic portion of a vinyl acetate acrylic acid cellulose polymer matrix include cellulase, cellobiohydrolase, and beta-glucosidase.

The polymer matrix with molecules polymerized into the backbone, such as starch and cellulose, may be blended with appropriate enzymes such that the polymer matrix will break down over time. The enzymes may be blended into the polymer matrix in a large amount or a small amount, depending upon how fast the polymer matrix is intended to break down over time.

In another embodiment, the enzyme is encapsulated in a secondary polymer, such as polyvinyl alcohol. This encapsulated enzyme is then incorporated into the polymer matrix, such as a vinyl acetate butyl acrylate copolymer, a vinyl acetate 2-ethyl hexyl acrylate copolymer, or modified version of a polymeric matrix such as a starch or cellulose modified version of a polymeric matrix.

As the ablative or sacrificial polymer degrades, the encapsulated enzyme may be released so as to further degrade the polymeric matrix. The encapsulating polymer for the enzyme may be modified to degrade at different rates depending upon the intended degradation of the polymer matrix. Also, the amount of the encapsulated enzyme in the polymer matrix may be modified so as to modify the ablative or sacrificial nature of the polymer matrix.

The enzymatic material may also be absorbed onto absorptive substrate such as silica gel, molecular sieves, and zeolites. This will allow the enzymatic material to be released over time as it desorbs from the absorptive substrate.

Natural polymers, such as a mixture of amylose and amylopectin, may also be utilized as a polymer matrix. Here, amylase may be utilized as an enzymatic degradation material to break down the amylose and amylopectin.

Enzymes may also be utilized to scission the backbone of the polymer forming the polymer matrix. These include both lipases and esterases. Enzymes act in a “lock” and “key” methodology where the enzyme will catalyze a chemical process at a high rate of reaction by temporarily bonding to a molecule (the “key”) to turn on a chemical reaction (the “lock”) and produce a new reaction product. This enzymatic interaction typically lowers the activation energy of the reaction process.

The enzymatic process may be throttled through several means including changes in pH, the elimination or addition of enzymatic cofactors, the addition of inhibitors that will bind to enzymatic sites, and changes in temperature. This enzymatic throttling process may be used to increase or decrease the ablative or sacrificial nature of the polymeric material.

Thus, several types of polymer matrix are described wherein a chemical moiety, such as a starch or cellulose, may be polymerized into the backbone of the polymer matrix so as to facilitate the ablative or sacrificial nature of the polymer matrix. This process may also be modified through the use of enzymatic materials where the enzymatic materials themselves may be modified to be more or less active through both encapsulation and enzymatic inhibition.

Quaternary ammonium salts are easily prepared through the reaction of tertiary amines with alkyl halides. This is typically known as the Menshutkin reaction and is shown in FIG. 3. This S_{N}2 type reaction involves nucleophilic substitution where an electron rich chemical moiety, the nucleophile, replaces a functional group in an electron deficient molecule, the electrophile. The “S_{N}” designation is an indicator that the substitution process is nucleophilic in nature and the fact that it proceeds via a biomolecular mechanism is indicated by the “2”. In contrast, an S_{N}1 reaction is also nucleophilic in nature but the rate determining step is unimolecular as indicated by the “1” and typically occurs with tertiary alkyl halides under strongly basic or strongly acidic conditions. The S_{N}2 reaction typically occurs with primary and secondary alkyl halides.

Halogenation of the polymer backbone may also be accomplished through various means. While the benzalkonium chloride molecule is the most common halogenated example, other halogens such as bromine and fluorine may also be added to the polymer backbone. The hydrohalogenation of alkenes allows for a hydrogen to attach to the primary carbon in the chain and the halogen, such as bromine, will attach to the secondary carbon for the major product while a minor product will be the addition of bromine to the primary carbon. This Markovnikov and anti-Markovnikov, respectively, will allow for the halogenation of unsaturated alkenes, double bonded materials, and alkynes, triple bonded materials.

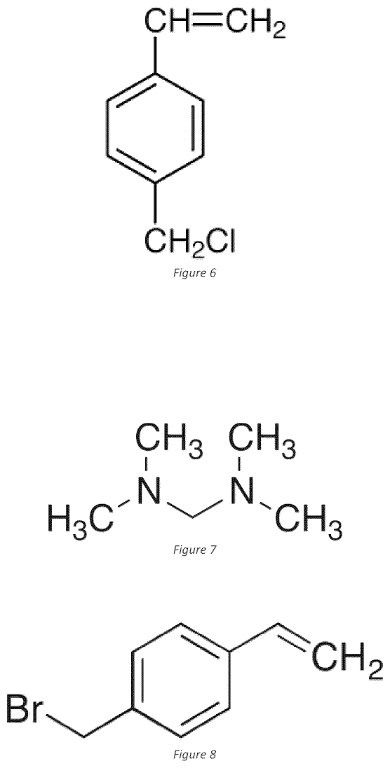

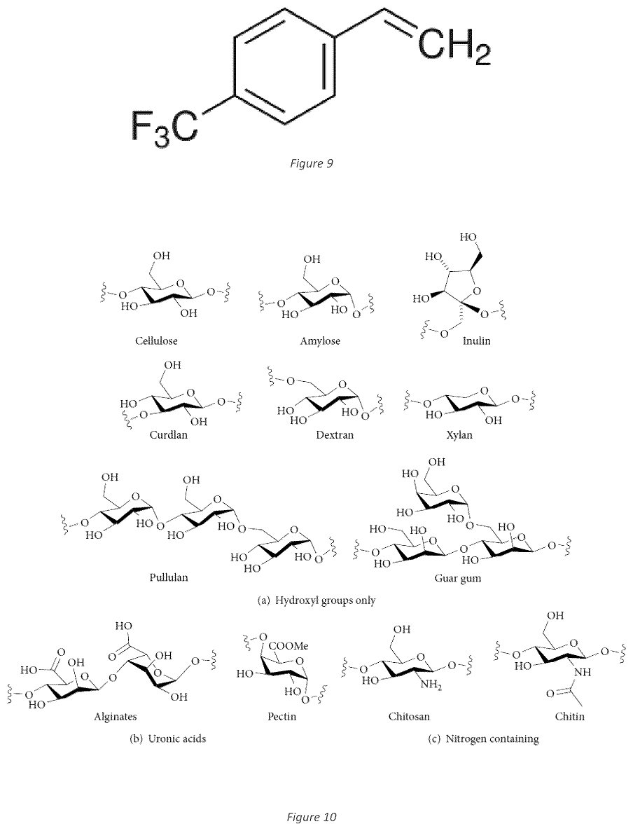

Formally, benzalkonium chloride type monomers were prepared utilizing chloromethyl styrene and N, N-dimethylalkylamine. Other styrenic type monomers may be produced through the modification of the vinyl group. See FIGS. 6 and 7 respectively.

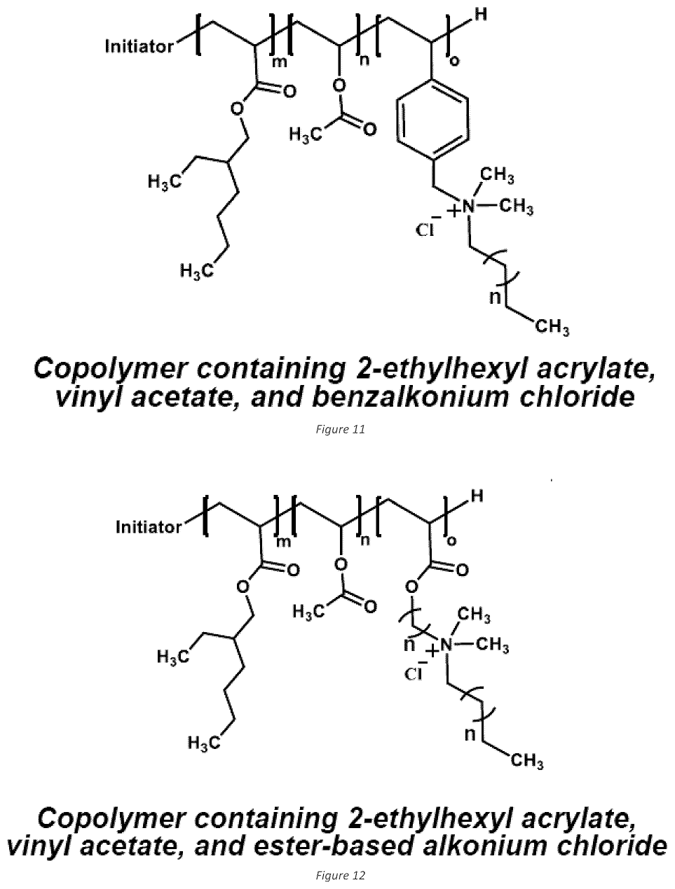

Polysaccharides may be utilized as a base polymer that is both ablative and pathogen inactivating. As an example, polysaccharides may be halogenated directly utilizing phosphine based conditions (triphenyl phosphine, abbreviated PPH₃, may be utilized along with Cl₂ or HBr for the chlorination or brominated and respectively of the polysaccharide molecule, specifically cellulose). Polysaccharides may also be nitrated, such as the addition of an amino group, through tosylation (the use of a toluenesulfonyl group to achieve active hydroxyl groups, an S_{N}2 reaction) and subsequent treatment with an azide compound. Several types of polysaccharides are shown in FIG. 10.

The polymer component may also be comprised of a specialized interpenetrating polymer network (IPN) where the polymer component of the IPN is two or more polymers of different morphology and chemistry. As an example, polymer one is a polyvinylacetate acrylic copolymer while the secondary polymer is a polysaccharide where the polysaccharide is functionalized with both a halogen and an amine moiety. The addition of a tertiary group, such as a alkyl modified benzalkonium chloride, will further diversify the ablative or sacrificial polymer along with the pathogen inactivating material.

The IPN may also be comprised of a polysaccharide polymer and a pathogen inactivating material such as a modified benzalkonium chloride. The benzalkonium chloride in this particular IPN may be modified to increase or decrease the affinity of the modified benzalkonium chloride for the polysaccharide via steric hindrance and/or modified van der Waals forces. The alkyl modification of the benzalkonium chloride either through the existing alkyl chain or modification of the aromatic ring component of the benzalkonium chloride.

Another polymer process that is possible for utilization with a pathogen inactivating material in an air filter media is the use of polymeric shape memory polymers. The activation and deactivation of the polymeric shape memory polymers will allow for exposure or non-exposure of the pathogen inactivating material depending upon environmental conditions that are acting upon the air filter media. For instance, shape memory polymers may be modified utilizing light, electricity, heat, or humidity.

Light induced changes in shape memory polymers include the use of different wavelengths of ultraviolet light impinged upon a carboxylic acid containing at least one unsaturated bond such as cinnamic acid. UV light of about 330 to 380 nm will have selective effects of compaction of the material while higher wavelength light such as greater than 420 nm will have an elongation effect on the molecule. By incorporating a pathogen inactivating material either as an IPN or directly attached to the backbone of the shape memory polymer, the different shapes of the shape memory polymer will allow for exposure or nonexposure of the pathogen inactivating material, depending upon the stimulation of the shape memory polymer.

Shape memory polymers may also be influenced by the humidity in the environment. For instance, with polyurethane shape memory polymers, the absorption of water will weaken the hydrogen bonding between the N—H and the C═O groups of the polyurethane shape memory polymer. This has the effect of lowering the glass transition temperature, T_{g}, and thus acting as a plasticizer for the polyurethane shape memory polymer. When a pathogen inactivating material is incorporated with the polyurethane shape memory polymer, the influence of the water content of the polyurethane shape memory polymer and the decrease in the T_{g} will allow for the pathogen inactivating material to be more readily available on the surface of the air filter media. As the humidity is removed, the T_{g} will increase and cause the pathogen inactivating material to be less available to the environment.

Fatty acid polymers may also be utilized as a basis or the pathogen inactivating material as well as the backbone polymer for coating the air filter media. Fatty acids are typically segregated into two major types these being saturated fatty acids where there are no double bonds in the backbone of the fatty acid and unsaturated fatty acids where there is at least one double bond in the backbone of the fatty acid. As an example, oleic acid, an unsaturated fatty acid, may be modified with both amine and halogenated materials to achieve an amine and halogen functionalized fatty acid.

Certain pathogen inactivating materials may be modified so as to be incorporated into vinyl acetate and acrylate copolymers. For instance, the aromatic group of benzalkonium chloride may be modified so as to polymerize the material into the backbone of the vinyl acetate 2-ethylhexyl acrylate copolymer. This binding of the benzalkonium chloride moiety into the vinyl acetate acrylic polymer backbone will allow for differential release of the benzalkonium chloride and differential interaction with the environment, such as pathogens that are entrained in an airflow that impinge upon an air filter that is modified with a vinyl acetate/acrylic incorporating the modified benzalkonium chloride molecule. The example of this molecule is shown in FIG. 11.

The benzalkonium chloride molecule may be further modified to eliminate the aromatic styrenic moiety and replace it with an ester linkage. The ester linkage when bound to the vinyl acetate acrylic backbone will allow for easier scission of the ester based alkonium chloride molecule where the release of the ester based alkonium chloride is desired.

Various biopolymers may also be used as the base polymer for supporting or incorporating or being copolymerize with a pathogen inactivating material such as benzalkonium chloride or an alkonium chloride that is functionalized with an ester linkage. Biopolymers that may be considered as the backbone polymer for the ablative or sacrificial polymer matrix include chitin, chitosan, and hyaluronic acid.

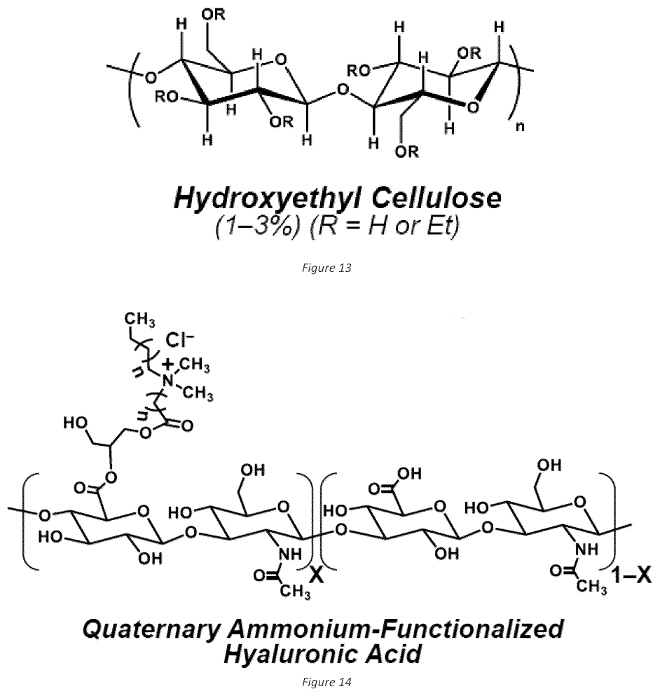

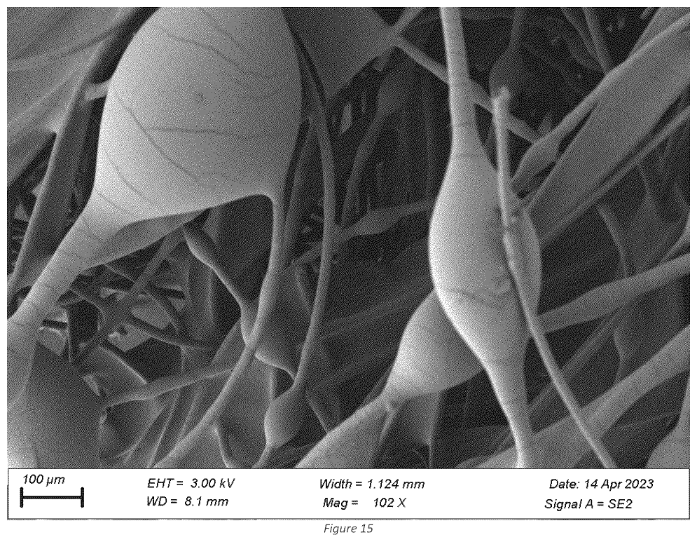

Hyaluronic acid is a biopolymer that may be further modified with pathogen inactivating materials. One such configuration is shown in FIG. 14 where an ester modified alkonium chloride is grafted onto the backbone of the hyaluronic acid polymer.

The recent spread of Candida auris points out the need for fungicidal as well as biocidal activity in air filtration. In several studies, it was shown that hydrogen peroxide, H₂O₂, is highly effective at the destruction of C. auris infections. It is somewhat impractical to include hydrogen peroxide as a liquid in air filters without any protection of the hydrogen peroxide from natural break down into water and oxygen gas. However, compounds such as calcium peroxide, CaO₂, and sodium percarbonate, Na₂H₃CO₆, will decompose to release hydrogen peroxide under certain environmental conditions. Typically, calcium peroxide requires an acidic condition to release hydrogen peroxide while sodium percarbonate will decompose into hydrogen peroxide and sodium carbonate when exposed to or dissolved in water.

Through the incorporation of materials such as calcium peroxide and sodium percarbonate into a ablative or sacrificial polymer, the resultant hydrogen peroxide decomposition material from the material such as calcium peroxide and sodium percarbonate may occur over time depending upon the ablation or sacrifice of the polymer matrix surrounding the calcium peroxide or sodium percarbonate. Thus, a slow breakdown of the ablative or sacrificial polymer will allow for a continued exposure of hydrogen peroxide to the environment of the air filter over time. Secondary agents, such as peracetic acid, CH₃CO₃H, may be utilized to activate materials such as calcium peroxide to release hydrogen peroxide. The secondary agents may be utilized as an admixture with an ablative or sacrificial polymer where the secondary agents and ablative or sacrificial polymers are separate from the hydrogen peroxide producing material, such as calcium peroxide. As such there may be a primary ablative or sacrificial polymer and a secondary ablative or sacrificial polymer where one ablative or sacrificial polymer with a secondary agent may be utilized in the same matrix as an ablative or sacrificial polymer with the hydrogen peroxide producing material, thus keeping the secondary agent and the hydrogen peroxide producing material separate until the primary and secondary ablative or sacrificial polymer begins to break down and cause the release of hydrogen peroxide.

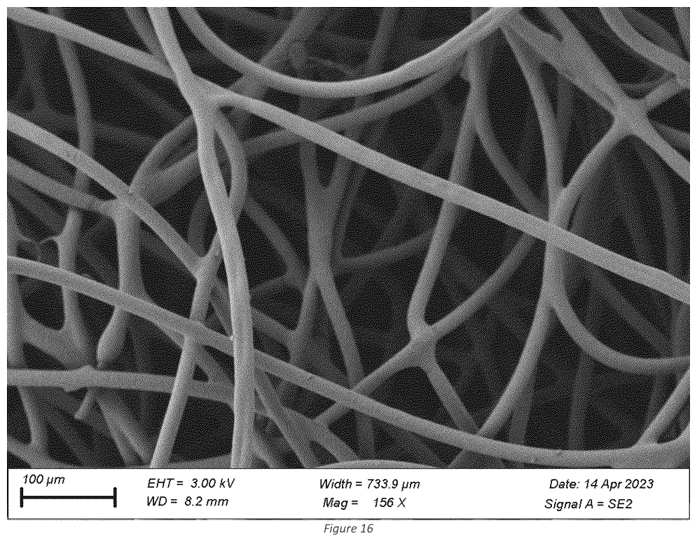

In the case of a spray process, the particles in the spray stream may be modified so as to penetrate into the woven or nonwoven substrate that is being utilized as the base material for the air filter. This may be done through regular atomization of the polymer matrix and pathogen inactivating material mixture. The atomization of the spray of the polymer matrix and pathogen inactivating material matrix solution may also be enhanced through various methods such as the use of a high velocity low pressure (HVLP) spray nozzle. A piezoelectric spray nozzle may also be utilized to improve the atomization of the polymer matrix and pathogen inactivating material solution. Atomized and subsequently dried polymeric materials may be seen in an SEM micrograph in FIG. 15 at various depths in a filamentous matrix that constitutes the substrate of one type of air filter. A similar SEM micrograph in FIG. 16 shows the filamentous substrate without a coating.

The decrease or lowering of the viscosity of the polymer and biocide additive formulation to achieve better penetration into the filter and therefore better efficacy in terms of reducing viral loads post-filtration is also an important component of the embodiment. This may be achieved by several means.

Diluting the concentration (i.e., polymer and biocide additive weight %) of the spray formulation will allow for a lower viscosity of the spray formulation overall and thus achieve further penetration into the filtration substrate. The addition of surfactants such as sodium dodecyl sulfate will also lower the surface tension of the formulation and allow for improved flow both into and around the individual filaments of the substrate material. Such a reduction in viscosity may be rather dramatic. As an example, through further dilution with deionized water, an emulsion polymer may be reduced from several thousand centiPoise (cPs) to less than 100 cPs.

In a spray operation, the airflow around and through the filtration substrate will also affect the penetration of the polymer and biocide additive when sprayed on the filtration substrate. By pulling a vacuum on one side of the filter before, during, or after the polymer has been sprayed onto one side of the filtration substrate or onto the opposite side of the filtration substrate to draw more of polymer coating into the filtration substrate. As an example, side a of the filtration substrate may be sprayed with the polymer and biocide coating. The substrate may then be turned to the opposite side and a vacuum pulled on the filtration substrate while a subsequent polymer and biocide coating is sprayed to the former opposite side of the filtration substrate.

In yet another embodiment of the application of the polymer and biocide additive coating, the polymer coating may be sprayed onto the filtration substrate in several dilute layers, with drying or curing steps in between applications. This process of spraying and drying may be further accelerated through the use of high vapor pressure solvents such as acetone. This will allow the volatile portion of the coating to “flash off” quickly so that the subsequent application may be done in a timely and cost-effective fashion.

Instead of a spraying operation, the filter may be immersed in a liquid bath of the polymer and biocide additive where the liquid bath is of an appropriate viscosity such that soaking the filter in a polymer and biocide additive solution will allow penetration into the filter substrate without a coating the filter substrate so as to reduce the airflow through the filter substrate. As an example, the filter substrate is dipped into a liquid bath of the polymer and biocide additive at a viscosity of 500 centipoise. The filter substrate now infused with the polymer and biocide additive is then removed from the liquid bath and the excess polymer and biocide additive are allowed to drain from the filter substrate. The now polymer and biocide additive coated filtration substrate is subsequently dried or cured to fully fix the polymer and biocide additive to the filtration substrate.

Molecular weight is an important component of the physical characteristics of a polymer. Typically, the weight average molecular weight has a greater effect on a polymers physical characteristics than does the number average molecular weight. Therefore, a decrease of the molecular weight of the polymers in the formulation, either number average molecular weight, weight average molecular weight, or both, will also decrease the viscosity of the polymer and biocide additive mixture. Through the reduction of molecular weight and by making the solution more dilute will allow for improved polymer uptake into the filter.

In one aspect of the polymer matrix with the pathogen inactivating material, an indicator dye or colorants may be utilized so as to indicate the coverage of the sprayed material onto a substrate or the color of co-mingled fibers of the polymer matrix with the pathogen inactivating material in a filamentous substrate. An indicator dye or colorants may be utilized also to indicate the lifespan of the filter system and when a replacement is necessary. For instance, a blue dye may be added to the polymer matrix and pathogen inactivating solution such that, after the solution is sprayed and dried onto a substrate, the die will fade over time, such as 30 days, the indicate the need for the replacement of the air filter.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A polymer comprising: a pathogen inactivating component such that the pathogen inactivating component is released continuously over time by the ablation or sacrifice of the polymer.

2. The polymer in claim 1 where the polymer is utilized in an air filter.

3. The polymer in claim 1 where the polymer is a polylipid.

4. The polymer in claim 1 where the polymer is halogenated.

5. The polymer in claim 1 where the polymer is comprised of a polysaccharide.

6. The polymer in claim 1 where the polymer is comprised of a shape memory polymer.

7. The polymer in claim 1 where the polymer is comprised of a base polymer and an enzyme.

8. The polymer of claim 1 where the polymer is comprised of an interpenetrating polymer network.

9. The polymer of claim 1 where the pathogen inactivating component is bound to the polymer.

10. An air filter comprising: a filamentous substrate, where the filamentous substrate is a mixture of different filament types; and
where one of the filament types is an ablative or sacrificial polymer incorporating a pathogen inactivating material.

11. The polymer of claim 1 where the polymer is a polymer filament.

12. The polymer filament of claim 11 where the pathogen inactivating material is bound to the polymer that comprises the polymer filament.

13. A polymer matrix comprising: a polymer mixed with a pathogen inactivating material where the polymer is an ablative or sacrificial polymer; and
where the ablative or sacrificial polymer will degrade over time in either a surface or bulk degradation method

14. The polymer matrix of claim 13 where the polymer matrix contains a degradation labile polymer.

15. The polymer matrix of claim 13 may also include an enzyme where the enzyme will increase the speed of the degradation of the polymer matrix either through an ablative process or a sacrificial process.

16. The polymer matrix of claim 13 where the polymer matrix further comprises an absorptive material such as a silica gel, molecular sieve, clay, or zeolite material.

17. A method of producing an air filter comprising: a blend of multiple filaments where a portion of the filaments are polymeric and are comingled with different polymeric or non-polymeric filaments; and
where a portion of the polymer filaments are ablative or sacrificial.

18. The method of claim 17 where the ablative or sacrificial polymer filaments contain a pathogen inactivating material.

19. The method of claim 18 where the pathogen inactivating material is bound to the polymer backbone of the ablative or sacrificial polymer filaments.

20. A polymer comprising: a pathogen inactivating component such that the pathogen inactivating component is released continuously over time by the ablation or sacrifice of the polymer; and
where the weight average molecular weight of the polymer is modified to achieve a lower viscosity.

21. The polymer of claim 20 where the weight average molecular weight is less than 75,000 Daltons.

22. A polymer mixture comprising: a pathogen inactivating component such that the pathogen inactivating component is released continuously over time by the ablation or sacrifice of the polymer; and
where the polymer mixture originally contains a low vapor pressure solvent; and
where the polymer mixture subsequently is diluted with a high vapor pressure solvent.

23. The polymer mixture of claim 21 where the high vapor pressure solvent has a vapor pressure greater than 23 torr at 25° C.; and
where the low vapor pressure solvent has a vapor pressure of greater than 154 torr at 25° C.
